(19) United States
(12) Patent Application Publication
(10) Pub. No.: US 2007/0007786 A1
(43) Pub. Date: Jan. 11, 2007

(54) Opposed drawer assembly for vehicles

(76) Inventor: Ronald A. Doyle, Yakima, WA (US)

Correspondence Address: JENSEN + PUNTIGAM, P.S., SUITE 1020, 2033 6TH AVE, SEATTLE, WA, 98121, US

(21) Appl. No.: 11/361,336

(22) Filed: Feb. 24, 2006

Related U.S. Application Data
(63) Continuation-in-part of application No. 11/178,228, filed on Jul. 8, 2005.

(51) Int. Cl. B60R 7/00

(52) U.S. Cl. 296/37.1

(57) ABSTRACT

A drawer assembly for vehicles, and more particularly to a system of opposed drawers for use in a vehicle or trailer, the drawers integrated into the structure of a vehicle for storage or concealment of the retractable features. The drawer assembly includes an upper drawer and a lower drawer, the bottom or pan of the upper drawer bottom located in substantially the same horizontal plane as the bottom or pan of the lower drawer, and with an upper drawer rail mounted to the upper drawer and a lower drawer rail mounted to the lower drawer. The upper and lower drawer rails having a rail length greater than the length of the drawer. The upper drawer rail slidably received by a bulkhead upper rail, and the lower drawer rail slidably received by a bulkhead lower rail, the bulkhead lower rail positioned parallel to and directly beneath the bulkhead upper rail, and an extended rail portion of the upper drawer rail positioned directly above the lower drawer rail, when both the upper drawer the lower drawer assembly are in a retracted position.

### TECHNICAL FIELD

This application is a continuation-in-part of U.S. Ser. No. 11/178,228, filed Jul. 8, 2005, by Ronald A. Doyle.

The invention relates to a drawer assembly for vehicles, and more particularly to a system of opposed drawers for use in a vehicle or trailer, the drawers are integrated into the structure of the vehicle for storage or concealment of items and include retractable features that allow complete access to the items within the drawers.

### BACKGROUND OF THE INVENTION

Externally accessed storage compartments are a common feature in trailers, trucks, busses, motor homes and recreational vehicles. Storage compartments, cargo areas, lockers and “stowage” are typically accessed from the exterior of the vehicles by upwardly opening doors, mounted on the outside surface of the vehicle. To provide for easier access to these interior storage compartments; drawers, trays and bins have been utilized. An example of a storage drawer is found in U.S. Pat. No. 6,328,365, to Adsit, which discloses an assembly for two drawers that suspend from a common pair of rails within a truck. The drawers are accessible from opposite sides of the truck. A disadvantage of this assembly is that the drawers, when fully extended from the truck, are only supported by a tip end of their slides. If the drawers contain heavy objects, the drawers will tend to tip down, breaking off and away from the rails.

An example of a “slide out” tray or deck is disclosed in U.S. Pat. No. 6,869,092 to Henn, which discloses a deck that is slideably movable from a retracted position beneath a vehicle to an extended position at only one side of the vehicle. An extendable tray system is needed that provides for extension from both sides of a vehicle for ease of access, the tray desireably having the same dimensions on both vehicle sides.

The present invention addresses the failings of prior vehicle drawer mechanisms, and can be understood by reference to the following detailed description taken in conjunction with the accompanying drawings.

### BRIEF DESCRIPTION OF DRAWINGS

FIG. 1 is a perspective view of a motor coach including an opposed drawer assembly, according to an embodiment of the invention;

FIG. 2 is a partially sectioned front elevation view of an opposed drawer assembly, according to an embodiment of the invention;

FIG. 3 is a partially sectioned side elevation view of an opposed drawer assembly in an open position, according to an embodiment of the invention;

FIG. 4 is a partially sectioned side elevation view of an opposed drawer assembly in a closed position, according to an embodiment of the invention;

FIG. 5 is a top view of an opposed drawer assembly in an open position, according to an embodiment of the invention;

FIG. 6 is a top view of an opposed drawer assembly in a closed position, according to an embodiment of the invention;

FIG. 7 is a perspective view of an opposed drawer assembly, according to an embodiment of the invention; and

FIG. 8 is a perspective view of an opposed drawer assembly, according to an embodiment of the invention;

FIG. 9 is a perspective view of an opposed drawer assembly, according to an embodiment of the invention.

FIG. 10 is a perspective view showing the interrelationship between the structural framework, the chassis elements and the closed drawer assembly.

FIG. 11 is a perspective view showing the interrelationship between the structure of the opposed drawer assembly and the supporting floor, including the drawer activation mechanism.

FIG. 12 is a perspective view showing the interrelationship between the chassis elements, the drawer support elements and the drawer activation elements.

FIG. 13 is a front end view of a motor coach showing the interrelationship between the extended sidewalls of the motor home and the extended opposed drawer assembly.

### DETAILED DESCRIPTION OF SPECIFIC EMBODIMENTS

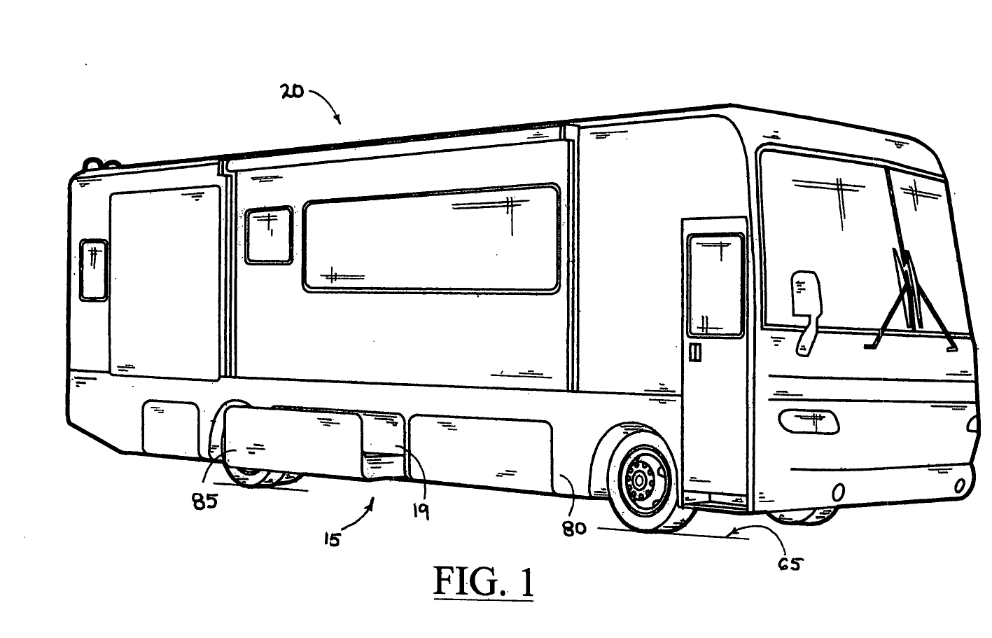

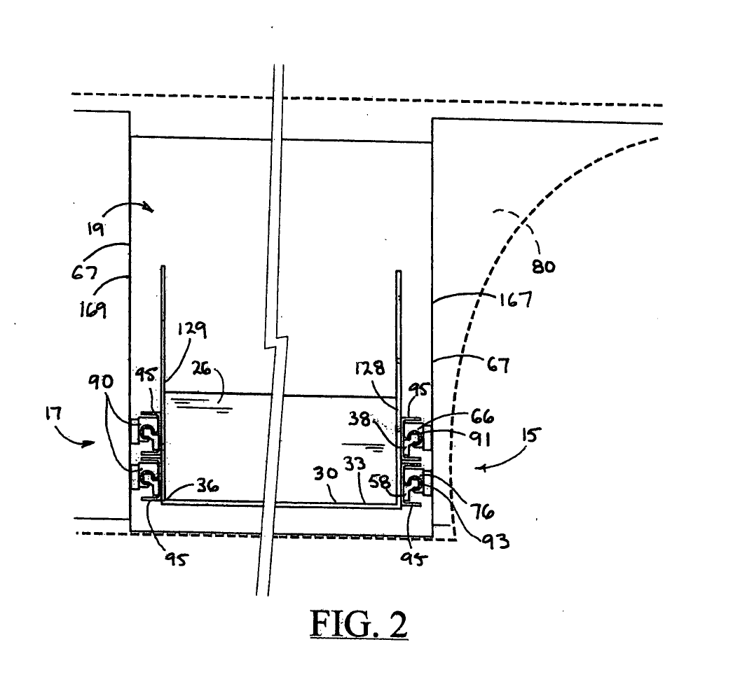

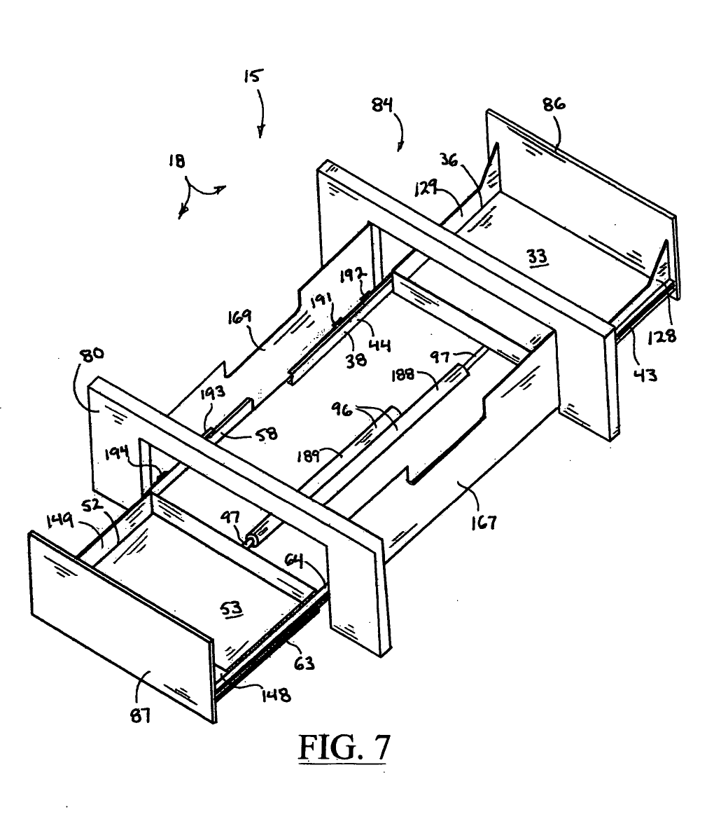

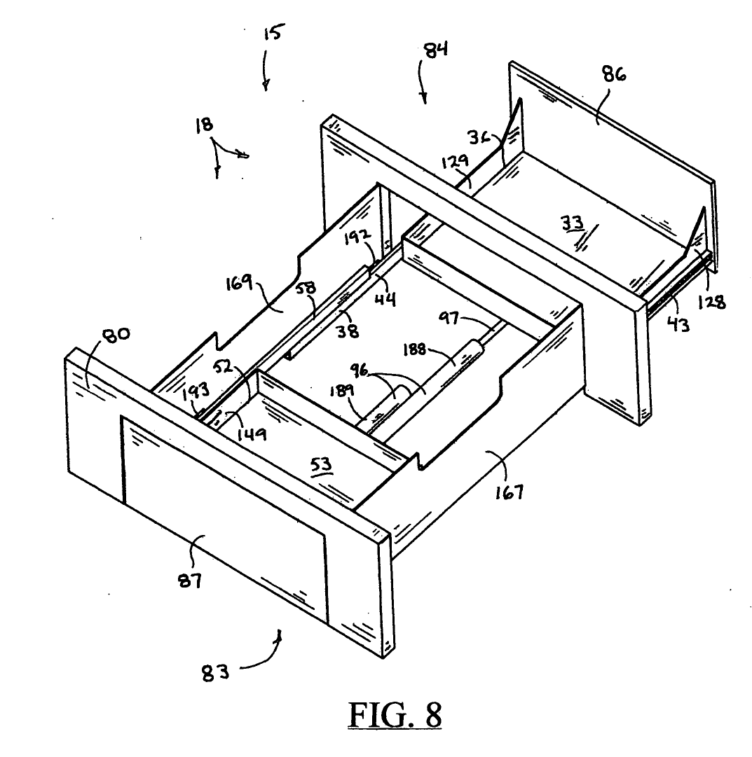

The invention provides a system of opposed drawers, and more particularly an opposed drawer system 15, as shown in FIGS. 1 through 9. For the invention, the drawer system includes stacked drawer rails 17 (See FIG. 2), which provide the system with the advantage of allowing a pair of opposed drawers 18 to extend from and retract into a storage compartment 19, without mechanical interference between the pair of opposed drawers or their rails. The opposed drawer system of the present invention is especially suited for use with a vehicle 20, preferably a recreational vehicle or “RV” or bus, which typically have large storage compartments, which are spaces or “holds,” often built within their undercarriages.

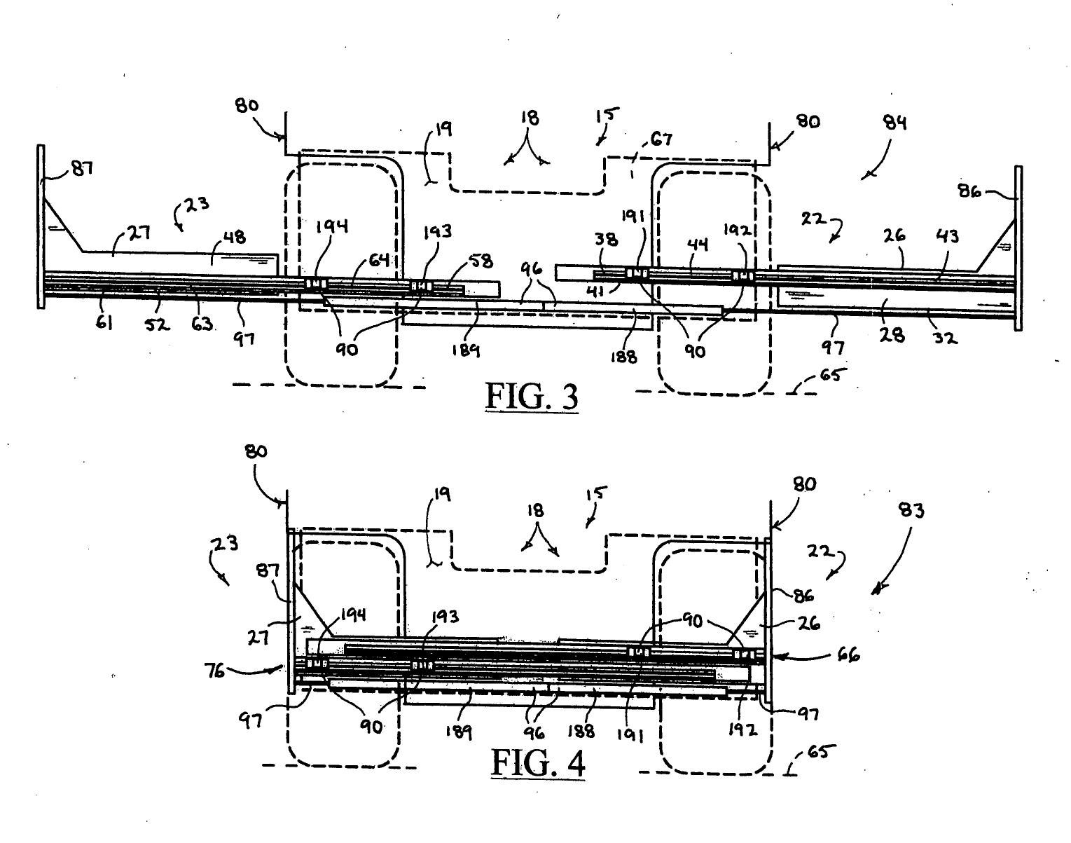

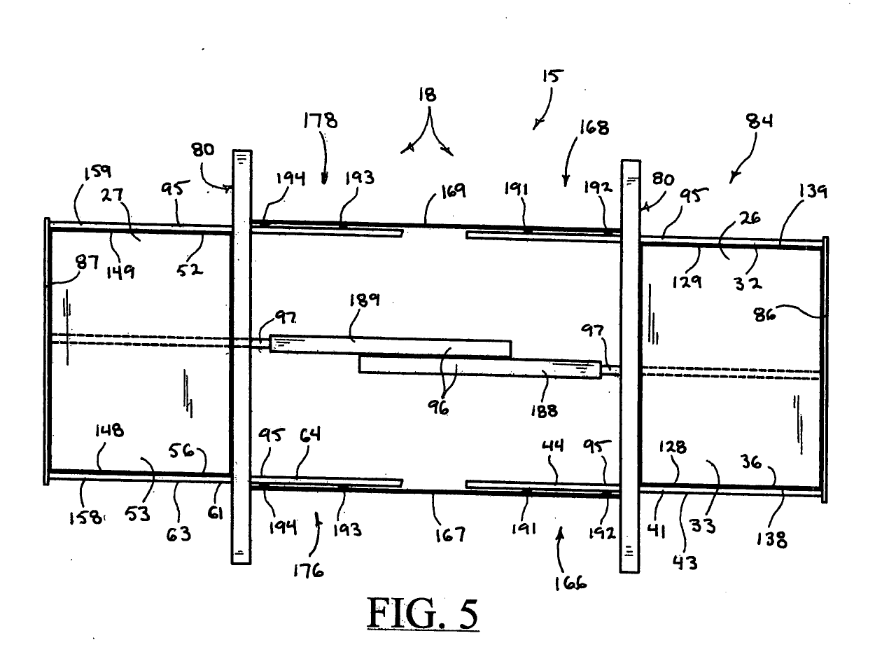

As detailed in FIGS. 3 and 4, the opposed drawer system 15 has an upper drawer assembly 22 and a lower drawer assembly 23. The upper drawer assembly includes an upper drawer 26, and the lower drawer assembly includes a lower drawer 27. As preferably employed for drawers, the upper drawer, or “first drawer,” is positioned opposed to the lower drawer, or “second drawer,” as shown in FIG. 5. For the purpose of the present invention, the opposed upper and lower drawers could alternatively also be in the form of opposed trays, platforms or “slide-outs.”

The upper drawer 26 and the lower drawer 27 both have sides, as do all conventional drawers. Specifically, the upper drawer includes an upper drawer side 28, as detailed in FIG. 3. When, in an alternative to drawers, trays are employed, the “sides” may be small upturns in a tray bottom 30, located between the sides of the tray or drawer, as preferred. The upper drawer side has an upper side length 32, and an upper drawer bottom 33. The upper drawer bottom separates the upper side from an opposing upper side, and the upper side length is the length of an upper joining 36, between the upper drawer sides and the upper drawer bottom. The upper drawer bottom may be a “pan” or a tray, or any other similar element. Additionally, an upper drawer rail 38 mounts to the upper drawer side of the upper drawer.

The upper drawer rail 38 can be formed from a metal strip or bar, with preferably a “C,” or an “L” shape, when viewed end-on. A “Z,” “I,” “T,” or “S” shape, or any other conventional rail form, are also considered as potential shapes for the upper drawer's rails. The upper drawer rail has an upper drawer rail length 41, which is greater than the upper side length 32. A preferred rail length for the upper drawer rail is approximately twice the upper side length, shown in FIG. 3. This longer length of the upper drawer rail, relative to length of the upper drawer side 28, allows the upper drawer 26 to extend fully or open for exterior access, while still providing support of the upper drawer, from the structure of the vehicle 20, adjacent to the storage compartment 19. This feature is discussed further, later in the present description. The upper drawer rail has an upper drawer rail portion 43 and an upper extended rail portion 44. The upper drawer rail portion of the upper drawer rail is positioned along the upper drawer side 28 of the upper drawer.

The lower drawer 27 includes a lower drawer side 48, as also detailed in FIG. 3, and similar to the upper drawer 26. For the lower drawer, the lower drawer side has a lower drawer side length 52, and a lower drawer bottom 53. The lower drawer bottom separates the lower side from an opposing lower side, and the lower side length is the length of a lower joining 56, which is located between the lower drawer sides and the lower drawer bottom. Like the upper drawer bottom 33, the lower drawer bottom may be a “pan” or a tray, or any other similar element. Additionally, a lower drawer rail 58 mounts to the lower drawer first side.

The lower drawer rail 58 can be fabricated from a metal strip or bar, as discussed above in reference to the upper drawer rail 38, with preferably a “C” or “L” shape, when viewed end-on, as with the upper drawer rail 38. Alternatively, the lower drawer rails preferably have a “Z,” “I,” “T,” or “S” shape, or any other conventional rail form, as potential shapes for the lower rail. The lower drawer rail has a lower drawer rail length 61, which is greater than the lower side length 52. A preferred rail length for the lower drawer rail is shown in FIG. 5. As described for the upper drawer assembly 22, above, this longer length of the lower rail, relative to length of the lower side, allows the lower drawer 27 to extend fully or open for access from outside the lower drawer, while still providing structural support for the drawer, from the structure of the vehicle 20, adjacent to the storage compartment 19.

The lower drawer rail 58 has a lower drawer rail portion 63, and a lower extended rail portion 64. In the operational configuration of the lower drawer assembly 23, as shown in FIG. 3, the lower drawer rail portion 63 of the lower drawer rail 58 is positioned along the lower drawer side 48 of the lower drawer 27.

Most preferably, the upper drawer bottom 33 is located in substantially the same horizontal plane as the lower drawer bottom 53, as shown in FIGS. 3 and 4. By the “same horizontal plane,” the bottom or “pan” of the upper drawer is at the same or a common level, at the same distance from a ground surface 65 beneath the vehicle 20. The upper drawer rail 38 is slidably received by a bulkhead upper rail 66, and the bulkhead upper rail is mountable to a bulkhead 67. The term “bulkhead” is used in the present specification and attached claims, to refer to an interior partition or wall of a ship, airplane, or any vehicle 20 of the sea, air or land, such as a recreational vehicle, a tow-able trailer, a truck or an automobile. The bulkhead, which is an integral part of the chassis, serves as substantially vertical partitions, separating the storage compartment 19, which receives the opposed drawer system 15 of the present invention, from the rest of the vehicle.

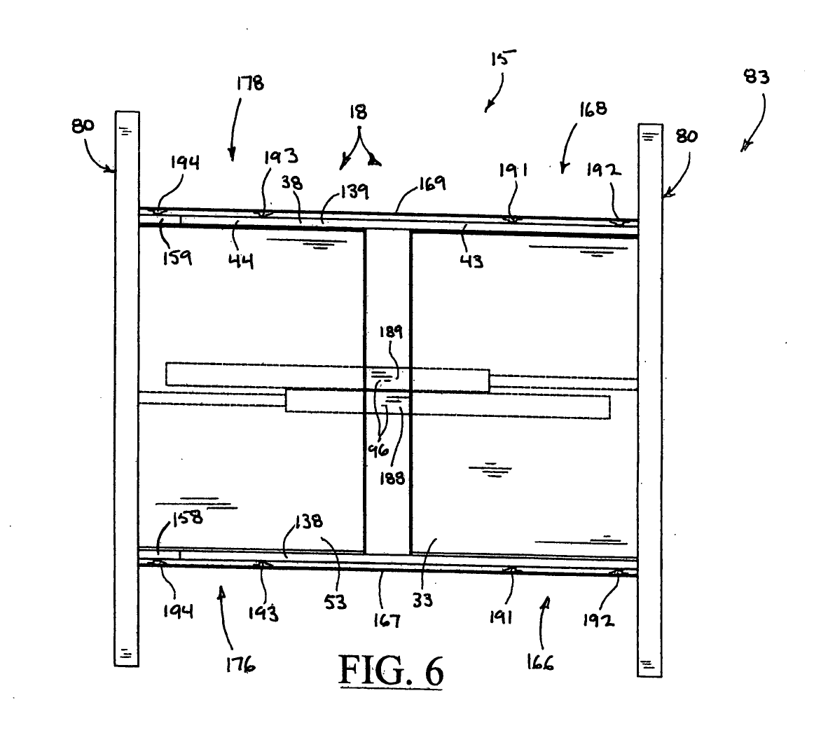

As shown in FIG. 6, and similar to the upper drawer assembly 22, the lower drawer rail 58 is slidably received into a bulkhead lower rail 76. The bulkhead lower rail is mountable to the bulkhead 67, and the bulkhead lower rail is most preferably positioned or oriented, parallel to and directly beneath the bulkhead upper rail 66. In a top view, as shown in FIG. 6, the bulkhead lower rail overlaps the bulkhead upper rail. In a side view, as shown in FIG. 4, the bulkhead lower rail is directly above the bulkhead upper rail.

The upper drawer assembly 22 and the lower drawer assembly 23, are each movable from a retracted position 83, as shown in FIG. 3, to an extended position 84, as shown in FIG. 4. In the retracted position, the upper drawer 26 or the lower drawer 27 are fully enclosed within the storage compartment 19 of the vehicle 20. Each drawer assembly preferably includes a door face panel 85. As shown in FIG. 4, an upper door face panel 86 covers the exposed exterior portion of the upper drawer assembly, when the upper drawer assembly is in the retracted position, and a lower door face panel 87 covers the exposed exterior portion of the lower drawer assembly, when the lower drawer assembly is in the retracted position.

Most preferably, the upper door face panel 86 is flush to an exterior surface 80 of the vehicle 20, when the upper drawer assembly 22 is in the retracted position 83. Additionally, the lower door face panel 87 is flush to the exterior surface 80 of the vehicle 20, when the lower drawer assembly 23 is in the retracted position.

To operate the opposed drawer system 15 of the present invention, a drawer drive 88 is preferably employed as an element of the upper drawer assembly 22 and the lower drawer assembly 23. Several alternative mechanisms can be employed as the drawer drive, to move the upper drawer 26, or the lower drawer 27, between the retracted position 83 and the extended position 84, and conversely between the extended position and the retracted position. These drawer drives can include motorized systems with electric motors to operate the drawers, and employ gears or pinions and racks; or simple manual push-pull systems, optionally supplemented with counterweights or springs to aid in the movement of the drawers; or pneumatic actuator systems; or servos; or any other mechanical, electrical or electromagnetic system; or, as most preferred, a hydraulic drawer drive system.

In this preferred drawer drive system 88 employing hydraulic power, an upper actuator 188 is positioned beneath the pair of opposed drawers 18, alongside a lower actuator 189, as shown in FIGS. 3 and 5. Both the upper actuator and the lower actuator include a cylinder 96 that mounts to the vehicle 20, and a piston 97 that attaches to one of the pair of opposed drawers. Most preferably, as shown in FIG. 3, the piston of the upper actuator attaches to the upper drawer face panel 86, and the piston of the lower actuator attaches to the lower drawer face panel 87.

In a preferred embodiment of the present invention, the drawer drive system 88 is operated remotely, with a remote transmitter or “key fob,” programmed to a receiver within the vehicle 20, that allow keyless entry into the vehicle and remote operation of the drive system, to alternatively extend or retract the pair of opposed drawers 18. This keyless, automatic operation of the opposed drawer system 15 allows the upper drawer face panel 86 and the lower drawer face panel 87 to be mounted flush to the exterior surface 80 of the vehicle, as shown in FIG. 1. A significant advantage of the present invention is that no external handle, latch, key hole, crank or access is needed to open either of the pair of opposed drawers 18. Alternately, an external touch pad, activated and deactivated from within the vehicle could be adjacent the drawer face panel.

In the extended position 84, each of the pair of opposed drawers 18 are open to the exterior of the vehicle, and ready for the placement or removal of items into the drawers. As shown in FIG. 3, when the upper drawer assembly 22 is in the extended position 84, the upper extended rail portion 44 of the upper drawer rail 38 is held and supported by the bulkhead upper rail 66. Additionally, when the lower drawer assembly 23 is in the extended position, the lower extended rail portion 64 of the lower drawer rail 58 is held and supported by the bulkhead lower rail 76.

As also shown in FIG. 4, and as preferred for the present invention, when the upper drawer assembly 22 and the lower drawer assembly 23 are both in the retracted position 83, the upper extended rail portion 44 of the upper drawer assembly's upper drawer rail 38 is positioned directly above the lower drawer rail portion 63 of the lower drawer assembly's lower drawer rail 58.

In a preferred alternative of the present invention, a set of rail guides 90, or “trucks” mount to the bulkhead 67, and serve to receive each drawer rail. Preferably, an upper truck 91 mounts to the bulkhead, replacing the bulkhead upper rail 66, and a lower truck 93 mounts on the bulkhead, replacing the bulkhead lower rail 67. Each truck receives and guides the travel of the respective drawer rail, as the drawers move back and forth, to and from the extended position 84 to the retracted position 83.

When the upper drawer 26 is in the retracted position 83, the upper truck 91 engages and slidingly grasps the upper drawer rail portion 43 of the upper drawer rail 38. When the upper drawer is in the extended position 84, the upper truck remains stationary, firmly mounted on the bulkhead 67, to engage and slidingly grasp the upper extended rail potion 44 of the upper drawer rail.

Specifically, the upper truck 91 mounts on the bulkhead 67, within the storage compartment 19, to receive the upper drawer rail 38. Most preferably, as shown in FIGS. 3 and 4, the upper truck is a pair of upper trucks, namely an inner upper truck 191, and an outer upper truck 192, each mounted to engage and slidingly grasp the upper drawer rail potion 43 of the upper drawer rail 38. Preferably, when the upper drawer 26 is in the retracted position 83, the outer upper truck is permanently located, preferably with bolts or screws, on the bulkhead near the upper drawer face panel 86, and the inner upper truck is permanently located on the bulkhead near the upper extended rail potion 44. These preferred locations of the upper trucks provide for optimally leveraged support, when the upper drawer is in the extended position 84, while additionally allowing for full extension of the upper drawer from the storage compartment 19.

Similarly, when the lower drawer 27 is in the retracted position 83, the lower truck 93 engages and slidingly grasps the lower drawer rail potion 63 of the lower drawer rail 58. When the lower drawer is in the extended position 84, the lower truck remains stationary, firmly mounted on the bulkhead 67, to engage and slidingly grasp the lower extended rail potion 64 of the lower drawer rail.

Specifically, the lower truck 93 mounts on the bulkhead 67, within the storage compartment 19, to receive the lower drawer rail 58. Most preferably, as shown in FIG. 5, the lower truck is a pair of lower trucks, namely an inner lower truck 193, and an outer lower truck 194, each mounted to engage and slidingly grasp the lower drawer rail portion 63 of the lower drawer rail 58. Preferably, when the lower drawer 27 is in the retracted position 83, the outer lower truck is permanently located, preferably with bolts or screws, on the bulkhead near the upper drawer face panel 86, and the inner upper truck is permanently located on the bulkhead near the lower extended rail potion 64. These preferred locations of the lower trucks provide for optimally leveraged support, when the lower drawer is in the extended position 84, while additionally allowing for full extension of the lower drawer from the storage compartment 19.

As an additional alternative to the preferred drawer rail and rail guide system, described above, the upper truck 91 and lower truck 93 may be employed in addition to the upper bulkhead rail 66 and lower bulkhead rail 76, respectively, instead of replacing them.

Most preferably, as detailed in FIG. 2, the drawer rail and rail guide system for use with the present invention is the DryLin® W linear guide system, as manufactured by igus USA, Inc., of E. Providence, R.I., with part number WSQ-20, for use as a preferred set of rail guides 90, specifically, the upper truck 91 and the lower truck 93. Additionally, DryLin® part number WJQM-01-20, is a preferred alternative for use as the upper drawer rail 38, and the lower drawer rail 58. The DryLin® systems provides a smoothly operating, dust and dirt resistant and low friction drawer rail and rail guide. Additionally, both the upper drawer rail and the lower drawer rail preferably includes a support channel 95, which is most preferably a “C” shaped element formed of a high strength extruded aluminum, or alternatively a stainless steel, employed to support and “house” the upper drawer rail and the lower drawer rail, as shown in FIG. 2.

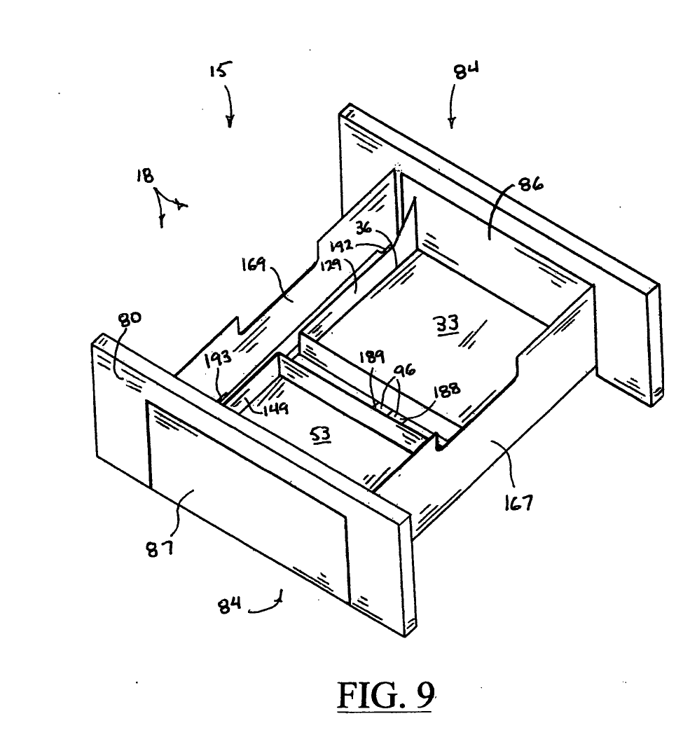

Preferably, the opposed drawer system 15 of the present invention includes stacked drawer rails 17, on both sides of the upper drawer assembly 22 and the lower drawer assembly 23. As discussed previously herein, the upper drawer 26 and the lower drawer 27 both have sides, as do all conventional drawers. Specifically, the upper drawer includes an upper drawer first side 128 and an upper drawer second side 129, as detailed in FIG. 9. For the upper drawer, the upper drawer first side and the upper drawer second side both have the upper side length 32, and the upper drawer bottom 33. The first upper side and the second upper side are separated by the upper drawer bottom, and the upper side length is the length of the upper joining 36, between the upper drawer sides and the upper drawer bottom. Additionally, an upper drawer first rail 138 mounts to the upper drawer first side of the upper drawer, and an upper drawer second rail 139 mounts to the upper drawer second side of the upper drawer.

The upper drawer first rail 138 and the upper drawer second rail 139 can be fabricated from a metal strip or bar, with preferably a “C,” or a “L” shape, when viewed end-on. The upper drawer first rail has the upper drawer rail length 41, which is greater than the upper side length 32. A preferred rail length for the upper drawer first rail is approximately twice the upper side length, shown in FIG. 3. This longer length of the upper drawer rail, relative to length of the upper drawer first side 128, allows the upper drawer 26 to extend fully, or open for exterior access, while still providing support of the upper drawer, from the structure of the vehicle 20, adjacent to the storage compartment 19. Again, this feature is discussed further, later in the present description.

The upper drawer first rail 138 also has the upper drawer rail portion 43 and the upper extended rail portion 44. The upper drawer rail portion of the upper drawer first rail is positioned along the upper drawer first side 128 of the upper drawer 26. Similarly, the upper drawer rail portion of the second upper drawer rail is positioned along the upper drawer second side 129 of the upper drawer.

The lower drawer 27 includes a lower drawer first side 148 and a lower drawer second side 149, as also detailed in FIG. 9, and similar to the upper drawer 26. For the lower drawer, the lower drawer first side and the lower drawer second side both have the lower drawer side length 52, and the lower drawer bottom 53. The lower drawer first side and the lower drawer second side are separated by the lower drawer bottom, and the lower side length is the length of the lower joining 56, which is located between the lower drawer sides and the lower drawer bottom. Additionally, a lower drawer first rail 158 mounts to the lower drawer first side, and a lower drawer second rail 159 mounts to the lower drawer second side.

The lower drawer first rail 158 and the lower drawer second rail 59 can be fabricated from a metal strip or bar, with preferably a “C,” or a “L” shape, when viewed end-on, as with the first upper drawer rail 138 and the second upper drawer rail 139. Again, any other conventional rail form is also considered as potential shapes for the lower rail. The first lower drawer rail has the lower drawer rail length 61, which is greater than the lower side length 52. As described for the upper drawer assembly 22, this longer length of the lower rail, relative to length of the lower side, allows the lower drawer 27 to extend fully, or open for access from outside the lower drawer, while still providing structural support for the drawer, from the structure of the vehicle 20, adjacent to the storage compartment 19.

The lower drawer first rail 158 has the lower drawer rail portion 63, and the lower extended rail portion 64. In the operational configuration of the lower drawer assembly 23, as shown in FIG. 4, the lower drawer rail portion 63 of the lower drawer first rail 158 is positioned along the lower drawer first side 148 of the lower drawer 27. Similarly, the lower drawer rail portion of the lower drawer second rail 159 is positioned along the second lower side 149 of the lower drawer.

Most preferably, the upper drawer bottom 33 is located in substantially the same horizontal plane as the lower drawer bottom 53, as shown in FIGS. 3 and 4. The upper drawer first rail 138 is slidably received by a first bulkhead upper rail 166, and the first bulkhead upper rail is mountable to a first bulkhead 167. Again, the term “bulkhead” is used in the present specification and attached claims, to refer to an interior partition or wall as an integral part of the chassis of a ship, airplane, or any vehicle 20 of the sea, air or land, such as a recreational vehicle, a tow-able trailer, a truck or an automobile. The bulkheads each serve as substantially vertical partitions, separating the storage compartment 19 from the rest of the vehicle.

Similar in form and function to the upper drawer first rail 138, the upper drawer second rail 139 is slidably received by a second bulkhead upper rail 168, and the second bulkhead upper rail is mountable to a second bulkhead 169. The second bulkhead is preferably parallel to the first bulkhead, and together with the first bulkhead, defines the limits of the storage compartment 19 within the vehicle 20, which receives the opposed drawer system 15 of the present invention.

As shown in FIG. 5, and similar to the upper drawer assembly 22, the lower drawer first rail 158 is slidably received into a first bulkhead lower rail 176. The first bulkhead lower rail is mountable to the first bulkhead 167, and the first bulkhead lower rail is most preferably positioned or oriented, parallel to and directly beneath the first bulkhead upper rail 166. In a top view, as shown in FIG. 6, the first bulkhead lower rail overlaps the first bulkhead upper rail. In a side view, as shown in FIG. 4, the first bulkhead lower rail is directly above the first bulkhead upper rail.

Similar to the lower drawer first rail 158, the lower drawer second rail 159 is slidably received by a second bulkhead lower rail 178, as shown in FIG. 5. The second bulkhead lower rail is mountable to the second bulkhead 169, and the second bulkhead lower rail is most preferably positioned parallel to and directly beneath the second bulkhead upper rail 168. Again, in the top view, as shown in FIG. 5, the second bulkhead lower rail overlaps the second bulkhead upper rail. In a side view, as shown in FIG. 3, the second bulkhead lower rail is directly above the second bulkhead upper rail.

As shown in FIG. 3, when the upper drawer assembly 22 is in the extended position 84, the upper extended rail portion 44 of the upper drawer first rail 138 is held and supported by the first bulkhead upper rail 166. Additionally, when the upper drawer is in the extended position, the upper extended rail portion of the second upper drawer rail 139 is held and supported by the second bulkhead upper rail 168.

As also shown in FIG. 3, when the lower drawer assembly 23 is in the extended position 84, the lower extended rail portion 64 of the lower drawer first rail 158 is held and supported by the first bulkhead lower rail 176. Additionally, when the lower drawer is in the extended position, the lower extended rail 64 portion of the lower drawer second rail 159 is held and supported by the second bulkhead lower rail 178.

As shown in FIG. 4, and as preferred for the present invention, when the upper drawer assembly 22 and the lower drawer assembly 23 are both in the retracted position 83, the upper extended rail portion 44 of the upper drawer assembly's upper drawer first rail 138 is positioned directly above the lower drawer rail portion 63 of the lower drawer assembly's lower drawer first rail 158.

Similarly, as also shown in FIG. 4, and also preferred for the present invention, when the upper drawer assembly 22 and the lower drawer assembly 23 are both in the retracted position 83, the upper extended rail portion 44 of the upper drawer assembly's second upper drawer rail 139 is positioned directly above the lower drawer portion 63 of the lower drawer assembly's lower drawer second rail 159.

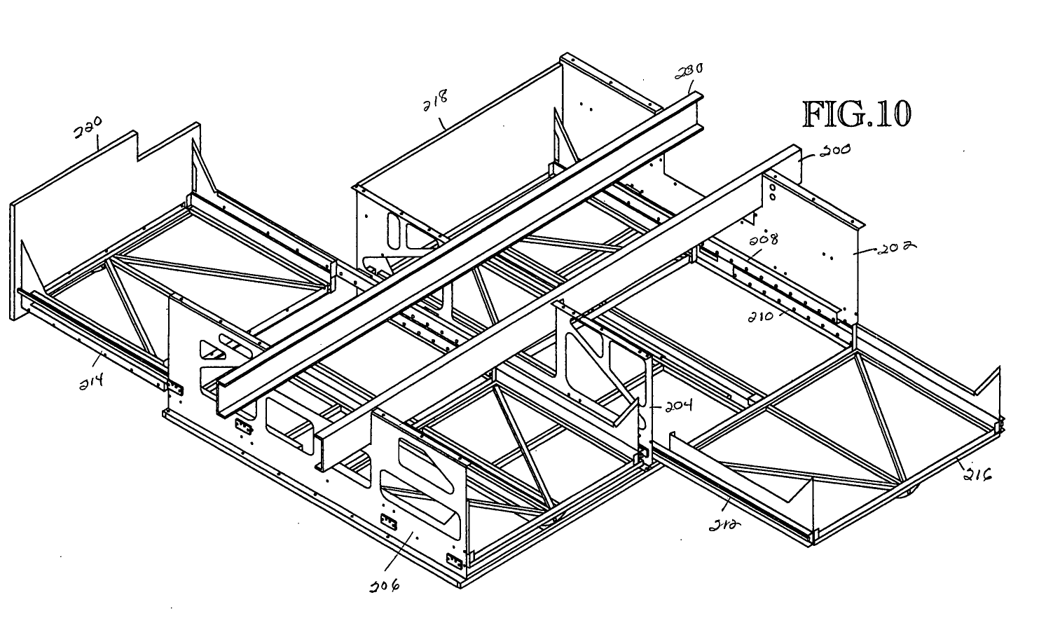

As seen in FIG. 10, the motor coach or other vehicle has a pair of parallel rails 200, which in one form or another, extend the entire length of the vehicle and support a plurality of outriggers or bulkheads, depending upon the purpose or required integrity of the particular horizontal cross piece. For the purposes of describing the present invention, there are shown three vertical bulkheads 202,204,206, which form a part of the chassis and are rigidly secured to the rails 200 and when completed by a floor member as described hereinafter form storage containing tunnels extending from one side of the vehicle to the other. In prior art vehicles these elements 202,204,206 have served primarily as dividers as opposed to structural members, the only requirement being that they separate the storage portion from the other portions of the vehicle and that they be of sufficient integral strength to support the floor and other matter carried within the storage area. As explained hereinabove, these storage areas have historically been closed with upwardly/open-hinged doors which create problems, as explained hereinafter, and require that an individual actually enter the compartment to retrieve items located at the rear of the compartment. Previous attempts at alleviating this problem have resulted in wheeled dollies being placed within the compartment, allowing the storage dolly to be moved from the back of the compartment to a more forward for more easy access. These wheeled dollies reduce the amount of storage available and further because of the fact that they were supported by wheels on the bottom of the storage compartment, did not allow for access to the rear of the dolly without partially entering the storage area. In the present invention, in addressing the solution to this problem, the bulkheads 202,204,206 were fabricated of a material with greater structural strength and patterned with cutouts where possible to reduce the weight of the device without affecting the structural integrity for the purposes. As explained in detail hereinbefore, a pair of support channels, including the necessary bearing elements, are secured to the inner side of each of the bulkheads and shown at 208,210, which are mated with channels 212,214 mounted to the sides of the drawer elements themselves, it being fully understood that the support channels are provided with sufficient bearing elements and that they appear in pairs, allowing the drawers to move outwardly to a position, as explained hereinafter, whereat the access to the contents is readily available and also to an inner position wherein the front frame 216 to which the front of the drawer is secured is co-planar with the exterior of the vehicle. As seen in FIG. 10 the two upper drawers, denoted as such since their rails are the upper pair of overlapping rails secured to the bulkhead, include front members 218,220 whereas the lower drawer members only show the drawer framework. It being understood as explained hereinbefore, that the drawer could be in fact a non-sided or low-sided tray, or in the alternative, could be a full drawer, including the front, sides and back. It is to be understood that the term “drawer” is used generically and is meant to convey a structurally complete container which may be supported by the side rails and moved inwardly and outwardly as desired.

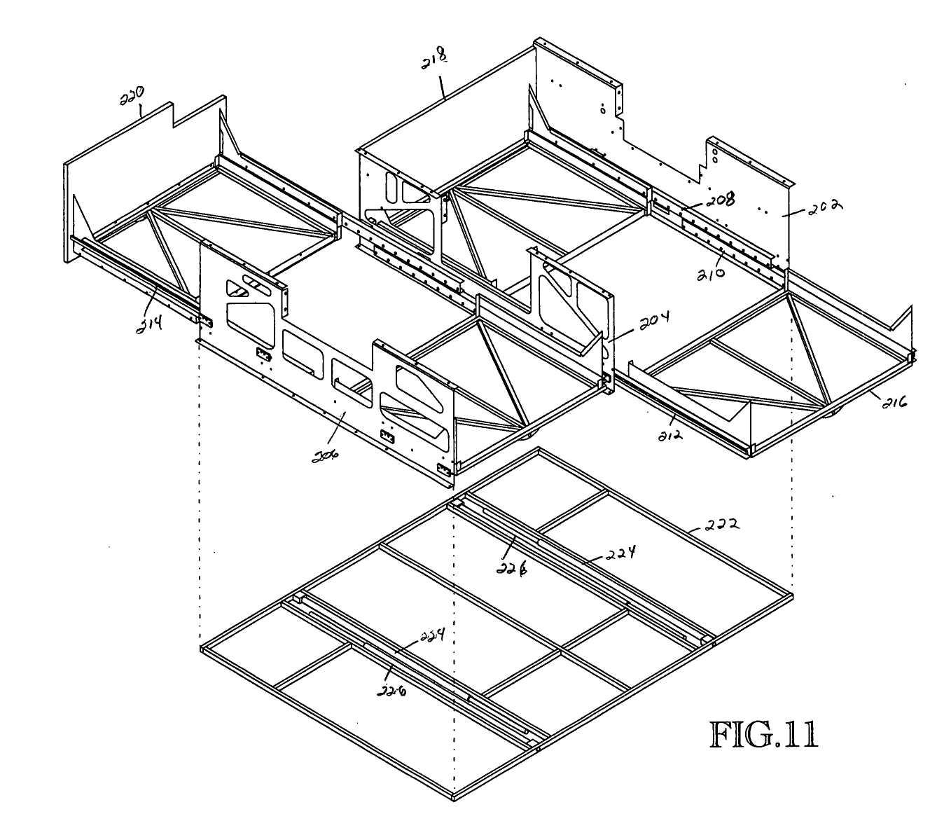

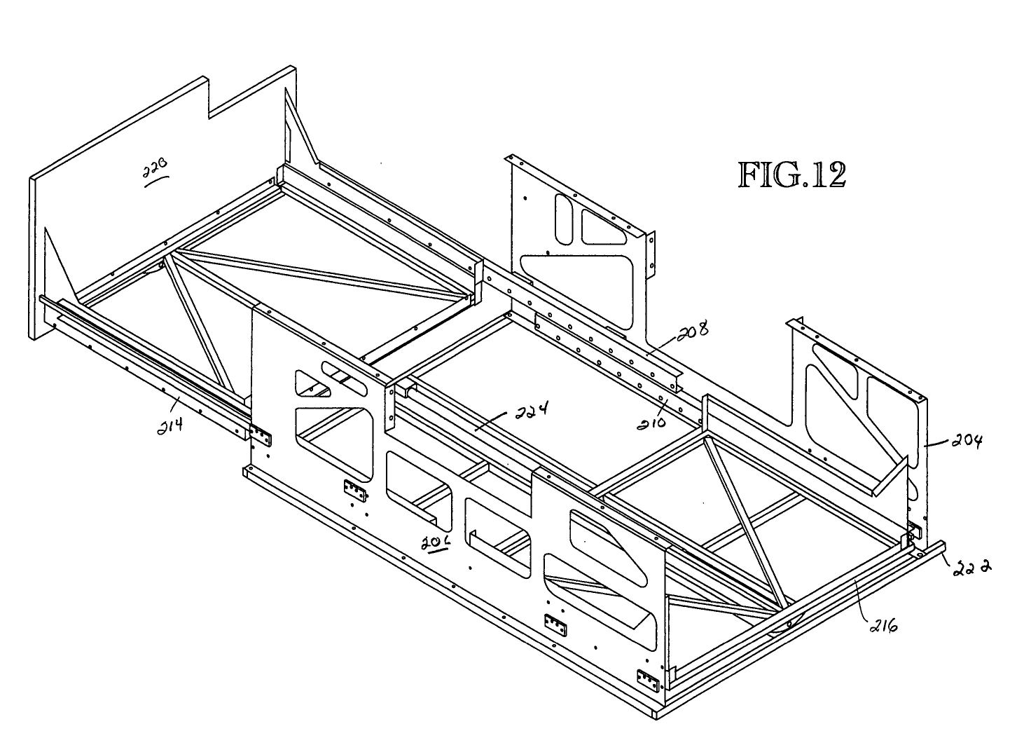

Reference is now had to FIG. 11, wherein it can be seen that the bulkheads, associated hardware and drawers have been exploded from the sub floor, includes a rigid framework 222 and more specifically two pair of opposing cylinders 224,226 mounted beneath the upper surface of the sub floor for maximizing the storage capacity, it being understood that each of the cylinders is mechanically engaged with a drawer selectively moving it from the open to the closed position.

The internal relationship of the various parts, including the port rails 208,210 are best seen in FIG. 12, it being understood that the bottom sides and back of the opposed drawer assemblies have been removed for clarity.

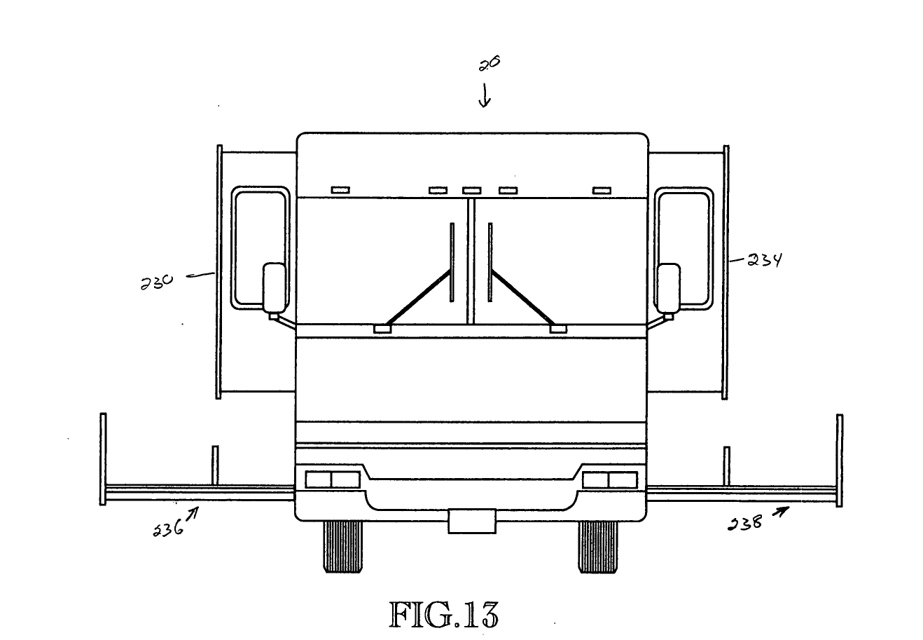

Reference is now had to FIG. 13 wherein the vehicle 20 is shown with the side walls expanded as at 230,234 and with a pair of opposed drawers 236,238 extended outwardly to the maximum illustrating that the access to the drawers is readily available even when both sidewalls are expanded. Further, as will be noted in this view, should the storage compartment be covered by a traditional top-hinged door, the access to the storage area be further impeded since the door could not swing upwardly much beyond the 90° mark.

Thus, as can be seen the present invention provides readily accessible storage beneath the floor of a motor vehicle such as a bus or motor home.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

1. A storage device for a motor coach having a pair of substantially parallel sidewalls comprising:
main horizontal frame members parallel to and between the sidewalls;
at least two vertical chassis members supported by the frame members extending outwardly therefrom and being substantially normal thereto;
an upwardly open box of a dimension to fit between adjacent chassis members; and
a pair of opposing suspension and guide members securing each side of the box to the adjacent chassis member, suspending the box and supporting it from its closed position behind the side wall and its open position outside the side wall.

2. A storage device as in claim 1, wherein a pair of the devices are mounted in opposing relationship, and each extendable outwardly of its side of the coach.

3. A motorized vehicle having opposing sidewalls including beneath the floor storage, wherein the storage capacity is maximized and accessed by pairs of opposing drawers mounted to vertical parallel chassis members for movement from a closed position whereat the front of the drawer is flush with a side wall to an open position whereat each drawer extends beyond the edge of an expanded sidewall, the drawers are suspended from overlapping rails permitting the full throw and driven by cylinders mounted beneath the under carriage.
